(19) United States
(12) Patent Application Publication
(10) Pub. No.: US 2025/0026641 A1
(43) Pub. Date: Jan. 23, 2025

(54) CUBIC CARBON NITRIDE CRYSTAL AND METHOD FOR PRODUCING SAME

(71) Applicant: THE DOSHISHA, Kyoto-shi, Kyoto (JP)

(72) Inventors: Takuya GOTO, Kyotanabe-shi, Kyoto (JP); Yuta SUZUKI, Kyotanabe-shi, Kyoto (JP); Masashi MORISHIMA, Kyotanabe-shi, Kyoto (JP)

(73) Assignee: THE DOSHISHA, Kyoto-shi, Kyoto (JP)

(21) Appl. No.: 18/709,962

(22) PCT Filed: Nov. 14, 2022
(86) PCT No.: PCT/JP2022/042271

§ 371 Date: May 14, 2024

(30) Foreign Application Priority Data
Nov. 15, 2021 (JP) 2021-185715

(51) Int. Cl. C01B 21/06; C25B 1/01; C25B 11/042; C25B 11/043

(52) U.S. Cl. CPC C01B 21/0605; C25B 1/01; C25B 11/042; C25B 11/043; C01P 2002/72

(57) ABSTRACT

The present invention provides a C₃N₄ having a cubic crystal system and a method for producing same.

### TECHNICAL FIELD

The present disclosure relates to a carbon nitride crystal with a cubic crystal structure, a method for producing the carbon nitride crystal, and a device for producing the carbon nitride crystal.

### BACKGROUND ART

In Non Patent Literature 1, carbon nitride represented by C₃N₄, especially carbon nitride with a cubic crystal structure (c-C₃N₄), is predicted to be present. Carbon nitride with a cubic crystal structure is calculated to have a hardness exceeding that of diamond. In addition to such high-hardness properties, cubic carbon nitride is also expected to have tribological, phosphor, and photocatalytic properties, thus making it a next-generation functional material.

Meanwhile, methods for producing carbon nitride (CNₓ), which have been reported, includes a production method utilizing an unbalanced magnetron sputtering method (Non Patent Literatures 2 and 3) and a production method of subjecting a mixture of a graphitic substance and a metal powder to an explosion treatment under high temperature and high pressure, for example.

### CITATION LIST

### Patent Literature

### Patent Literature 1

Japanese Patent Laid-Open No. 2000-51678

### Non Patent Literature

### Non Patent Literature 1

D. M. Teter, M. L. Cohen, Science, 271 (1996) 53-55.

### Non Patent Literature 2

E. Contreras, F. Bolivar, M.A. Gomez, Surface and Coatings Technology, 332 (2017) 414-421.

### Non Patent Literature 3

H. Kamiyama, O. Takai, Trans. Mat. Res. Soc. Japan, 44 (2019) 45-50.

### SUMMARY OF INVENTION

### Technical Problem

Carbon nitride represented by a C₃N₄ crystal with a cubic crystal structure (hereinafter also referred to as “cubic C₃N₄ crystal” or “c-C₃N₄”) is theoretically expected to exist, but there is no example of actual synthesis. In the production methods of Patent Literature 1 and Non Patent Literatures 2 and 3, the formation of carbon nitride has been confirmed, but the formation of carbon nitride having a stoichiometric ratio of C₃N₄, especially, c-C₃N₄ has not been confirmed. Specifically, crystalline carbon nitride is formed in Patent Literature 1, but there is no disclosure of data that identifies it as c-C₃N₄, and the stoichiometric ratio of carbon to nitrogen is 1:1 or 1:1.1. In Non Patent Literatures 1 and 2, the resulting carbon nitride is amorphous.

An object of the present disclosure is to provide c-C₃N₄ and a method for producing the same.

### Solution to Problem

The present disclosure includes aspects as described below.

A C₃N₄ crystal with a cubic crystal structure.
[2] The C₃N₄ crystal according to [1] above, which has peaks at 40.9°, 47.6°, and 69.6° (2θ) in an XRD pattern.
[3] The C₃N₄ crystal according to [1] or [2] above, which has a C₃N₄ concentration of 99.5% by mass or more in the crystal.
[4] The C₃N₄ crystal according to any one of [1] to [3] above, which has an edge length of 0.3 μm or more.
[5] A method for producing carbon nitride, comprising subjecting a molten salt containing carbon and nitrogen anions to pulse electrolysis to oxidize the carbon and nitrogen anions, thereby forming carbon nitride represented by C₃N₄.
[6] The method for producing carbon nitride according to [5] above, wherein the carbon and nitrogen anions are C₂²⁻and N³⁻, respectively.
[7] The production method according to [5] or [6] above, wherein a potential-time graph in the pulse electrolysis shows a rectangle.
[8] The production method according to any one of [5] to [7] above, wherein a potential during potential application is 0.10 to 5.00 V in the pulse electrolysis.
[9] The production method according to any one of [5] to [8] above, wherein a potential application time is 0.01 to 5.0 seconds in the pulse electrolysis.

The production method according to any one of [5] to [9] above, wherein a potential during a pause of potential application in the pulse electrolysis is an open circuit potential.

The production method according to any one of [5] to above, wherein a pause time of potential application is 1.0 seconds or more in the pulse electrolysis.

The production method according to any one of [5] to above, wherein the pulse electrolysis is performed under a nitrogen atmosphere or rare gas atmosphere.

The production method according to above, wherein the rare gas atmosphere is an argon atmosphere.

The production method according to any one of [5] to above, wherein an anode is an electrode of a noble metal, a conductive metal oxide, glassy carbon, natural graphite, isotropic graphite, pyrolytic graphite, plastic formed carbon, or boron doped diamond.

The production method according to any one of [5] to above, wherein the anode is a Pt electrode.

The production method according to any one of [5] to above, wherein a cathode is an electrode of Ag, Cu, Ni, Pb, Hg, TI, Bi, In, Sn, Cd, Au, Zn, Pd, Ga, Ge, Ni, Fe, Pt, Pd, Ru, Ti, Cr, Mo, W, V, Nb, Ta, Zr, or an alloy thereof, glassy carbon, natural graphite, isotropic graphite, pyrolytic graphite, plastic formed carbon, conductive diamond, or nitrogen.

The production method according to any one of [5] to above, wherein the cathode is a glassy carbon electrode.

The production method according to any one of [5] to above, wherein the molten salt is a molten salt of one or more salts selected from alkali metal or alkaline earth metal halides.

The production method according to any one of [5] to above, wherein a carbon anion source is CaC₂.

The production method according to any one of [5] to above, wherein a nitrogen anion source is Li₃N.

An electrolyzer comprising an anode, a cathode, and an electrolytic cell, wherein
a molten salt containing carbon and nitrogen anions is in the electrolytic cell, and
a pulse potential is applied between the anode and the cathode to oxidize the carbon and nitrogen anions to form C₃N₄.

The electrolyzer according to above, further comprising a reference electrode.

### Advantageous Effect of Invention

According to the present disclosure, a molten salt containing carbon and nitrogen anions is subjected to pulse electrolysis to oxidize the carbon and nitrogen anions, thereby forming carbon nitride represented by C₃N₄, particularly c-C₃N₄.

### BRIEF DESCRIPTION OF DRAWINGS

FIG. 1 is a schematic view of an electrolyzer 1 of the present disclosure.

FIG. 2 is a potential-time graph of pulse electrolysis in a method for producing carbon nitride according to the present disclosure.

FIG. 3 is a graph showing changes in current with time in Experimental Example 1 and Comparative Example 1.

FIG. 4 is a graph showing measurement results of XRD analysis of carbon nitride obtained in Examples 1 and 2.

FIG. 5 is a graph showing measurement results of XRD analysis of carbon nitride obtained in Examples 3 and 4.

FIG. 6 is a graph showing measurement results of XRD analysis of carbon nitride obtained in Examples 5.

FIG. 7 is an SEM image of carbon nitride obtained in Example 3.

FIG. 8 is an SEM image of carbon nitride obtained in Example5.

### DESCRIPTION OF EMBODIMENTS

Hereinafter, the present disclosure is described in detail. Note that the following description is intended to embody a technical concept of the invention according to the present disclosure and not to limit the invention of the present disclosure to those described below, unless otherwise specifically stated.

### <Carbon Nitride>

The present disclosure provides a C₃N₄ crystal with a cubic crystal structure.

The c-C₃N₄ crystal of the present disclosure preferably has peaks at 40.9°, 47.6°, and 69.6° (2θ) in an XRD (X-ray diffraction) pattern. 40.9°, 47.6°, and 69.6° are peaks of the (211), (220), and (400) planes, respectively. The C₃N₄ crystal of the present disclosure may further have a peak of 84.0° in an XRD (X-ray diffraction) pattern, where such a peak is the peak of the (332) plane.

In the present disclosure, X-ray diffraction analysis is performed using Cu—Kα radiation.

In the present disclosure, X-ray diffraction analysis is typically performed under the following measurement conditions:
Radiation source: Cu—Kα radiation
Scan range (2θ): 15 to 80°
Step size (2θ): 0.02°
Scanning speed: 0.5°/min
Voltage: 40 kV
Current: 20 mA

The c-C₃N₄ crystal of the present disclosure preferably has a regular octahedral structure.

In a preferred aspect, the c-C₃N₄ crystal of the present disclosure may have a regular octahedral structure with an edge length of 0.3 μm or more, preferably 0.5 μm or more, more preferably 0.8 μm or more, and even more preferably 1.0 μm or more, for example, 2.0 μm or more, 3.0 μm or more, or 5.0 μm or more. The upper limit of the edge length of the c-C₃N₄ crystal of the present disclosure may be, but is not particularly limited to, 100 μm or less, 50 μm or less, 10 μm or less, or 5 μm or less, for example.

The edge length of the c-C₃N₄ crystal above means an edge length of the regular octahedral structure of the crystal structure. The edge length of a c-C₃N₄ crystal can be measured by acquiring an image of the c-C₃N₄ crystal with a scanning electron microscope (SEM) to analyze such an image.

The c-C₃N₄ crystal of the present disclosure preferably has a bulk modulus of 200 GPa or more, more preferably 240 GPa or more.

In the present disclosure, the bulk modulus can be measured by a nanoindentation method.

The C₃N₄ content (i.e., purity) in the c-C₃N₄ crystal of the present disclosure is preferably 99.0% by mass or more, more preferably 99.5% by mass or more, and even more preferably 99.9% by mass or more.

In the present disclosure, the C₃N₄ content in the c-C₃N₄ crystal above can be measured using a glow discharge optical emission spectrometer.

The impurity content in the c-C₃N₄ crystal above may be preferably 0.1 at % or less, more preferably 0.01 at % or less. Examples of such impurities include atoms derived from the molten salt, such as metal atoms, oxygen atoms, and halogen atoms.

The c-C₃N₄ crystal of the present disclosure may have high hardness properties, tribological properties, phosphor properties, or photocatalytic properties and thus can be used in various applications as a functional material, for example, as an electronic material and an engineering material. Specifically, the c-C₃N₄ crystal can be used as a protective film on the surface of tools and as a solid lubricant due to its high hardness and tribological properties. Due to its excellent field electron emission properties, the c-C₃N₄ crystal can be used as an electron emitting material. Due to its photocatalytic properties, the c-C₃N₄ crystal can be used as an optical semiconductor material in an optoelectronic device. Due to its low dielectric properties, the c-C₃N₄ crystal can be used for an interlayer insulating film and a heavy particle ion detector.

### <Method for Producing Carbon Nitride>

The present disclosure provides a method for producing carbon nitride.

The method for producing carbon nitride according to the present disclosure includes subjecting a molten salt containing carbon and nitrogen anions, typically C₂²⁻ and N³⁻, to pulse electrolysis to oxidize the carbon and nitrogen anions, thereby forming carbon nitride represented by C₃N₄. The resulting C₃N₄ may have a cubic crystal structure. As used herein, the pulse electrolysis means an electrolysis method of alternately repeating the application of a potential and a pause.

### (Electrolyzer)

The pulse electrolysis of the present disclosure is usually performed in an electrolyzer having an anode, a cathode, and an electrolytic cell. Accordingly, the present disclosure also provides an electrolyzer for performing the pulse electrolysis of the present disclosure.

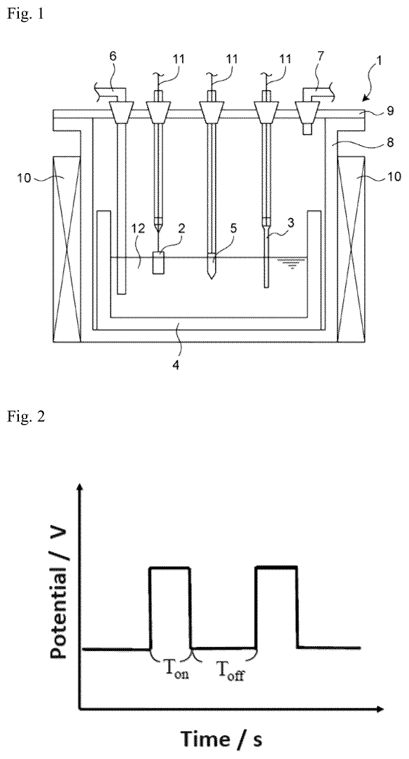

FIG. 1 shows one aspect of an electrolyzer of the present disclosure.

An electrolyzer 1 of the present disclosure includes an anode 2, a cathode 3, and an electrolytic cell 4. In the electrolytic cell 4, there is a molten salt 12 containing C₂²⁻ and N³⁻. The electrolyzer 1 may also include a reference electrode 5, a gas injection member 6, a gas exhaust member 7, a lower sealed container 8, an upper sealed container 9, and a heater 10. In the electrolyzer 1, a pulse potential is applied between the anode 2 and the cathode 3 to oxidize C₂²⁻ and N³⁻ to C₃N₄.

The anode 2, the cathode 3, and the reference electrode 5 are at least partially located in the molten salt 12. In other words, the anode 2, the cathode 3, and the reference electrode 5 are arranged such that at least a portion of them is in contact with the molten salt 12. The anode 2, the cathode 3, and the reference electrode 5 are connected by a conducting wire 11 to a device to apply a pulse potential, for example, a potentiostat (not shown). The molten salt 12 in the electrolytic cell 4 is heated to a predetermined temperature or higher by the heater 10. The anode 2, the cathode 3, the reference electrode 5, and the electrolytic cell 4 are arranged inside the lower sealed container 8, and sealed by the upper sealed container 9 to be kept under a sealed condition.

The gas injection member 6 is used to introduce inert gas into the sealed container from the outside. The tip of the gas injection member 6 may be located inside or above the molten salt 12. The gas exhaust member 7 is used to discharge gas inside the sealed container to the outside of the sealed container.

The material of the anode is not particularly limited. Examples of anode materials include noble metals (e.g., Au, Ag, and Pt), conductive metal oxides, glassy carbon, natural graphite, isotropic graphite, pyrolytic graphite, plastic formed carbon, and boron doped diamond. Examples of an electrode made of the conductive metal oxides include a transparent conductive electrode obtained by forming a film of a mixed oxide of indium and tin on glass, which is called an ITO electrode, and an electrode obtained by forming a film of an oxide of a platinum-group metal, such as ruthenium or iridium, on a base material such as titanium, which is called a DSA electrode (trademark of De Nora Permelec Ltd).

In a preferred aspect, the anode can be a noble metal electrode, preferably an Au, Ag, or Pt electrode, more preferably a Pt electrode. The use of a noble metal electrode as the anode increases reduction resistance of the electrode and enables a stable electrolysis reaction for a long time.

The material of the cathode is not particularly limited. Examples of cathode materials include metals such as Ag, Cu, Ni, Pb, Hg, TI, Bi, In, Sn, Cd, Au, Zn, Pd, Ga, Ge, Ni, Fe, Pt, Pd, Ru, Ti, Cr, Mo, W, V, Nb, Ta, Zr, alloys thereof, and carbon materials such as glassy carbon, natural graphite, isotropic graphite, pyrolytic graphite, plastic formed carbon, and conductive diamond. Alternatively, the cathode may be a nitrogen electrode.

In a preferred aspect, the cathode can be a glassy carbon electrode or a transition metal (e.g., Fe, Cu, and Ni), preferably a glassy carbon electrode. The use of the electrode above as the cathode, especially, a glassy carbon electrode, enables the electrode to be excellent in conductivity and resistant to high temperature.

In a more preferred aspect, the anode can be a Pt electrode while the cathode can be a glassy carbon electrode. The use of a Pt electrode as the anode and a glassy carbon electrode as the cathode makes it possible to carry out the electrolysis reaction at a high temperature and more efficiently.

In a preferred aspect, the electrolyzer has a reference electrode. The reference electrode is preferably an Ag⁺/Ag electrode.

In one aspect, the electrolyzer includes a gas injection member for injecting gas into the electrolytic cell or into the molten salt. Furthermore, the electrolyzer includes a gas exhaust member for exhausting the gas in the electrolytic cell.

### (1) Preparation of Molten Salt

First, a molten salt containing carbon and nitrogen anions, typically C₂²⁻ and N³⁻, is prepared. A preparation method of such a molten salt is not particularly limited as long as the carbon and nitrogen anions can be made to be in the molten salt.

In the present disclosure, the molten salt refers to a liquid obtained by heating and melting a metal salt or metal oxide as a raw material. The molten salt contains cations and anions derived from the metal salt or metal oxide as a raw material.

In one aspect, the molten salt containing carbon and nitrogen anions can be obtained by dissolving a carbon anion source and a nitrogen anion source in a liquid obtained by heating and melting the metal salt and/or metal oxide, or by melting a carbon anion source and a nitrogen anion source together with the metal salt and/or metal oxide. Alternatively, one of the carbon anion source and the nitrogen anion source may be dissolved first, and the other may be separately dissolved. Hereinafter, the “carbon anion source” and the “nitrogen anion source” are also simply referred to as a “C source” and an “N source”, respectively.

The metal salt and metal oxide as a raw material of the molten salt is preferably alkali metal, alkaline earth metal, or other metal, more preferably alkali metal or alkaline earth metal salt and oxide. In a preferred aspect, the raw material of the molten salt is a metal salt, preferably an alkali metal salt or an alkaline earth metal salt, more preferably an alkali metal salt. The molten salt can be prepared at a relatively low temperature by using the metal salt as a raw material.

Examples of the alkali metal include at least one selected from the group consisting of lithium (Li), sodium (Na), potassium (K), rubidium (Rb), cesium (Cs), and francium (Fr). The alkali metal is preferably at least one selected from the group consisting of Li, Na, K, Rb, and Cs, more preferably at least one selected from the group consisting of Li, Na, and K, particularly preferably Li or K.

Examples of the alkaline earth metal include at least one selected from the group consisting of beryllium (Be), magnesium (Mg), calcium (Ca), strontium (Sr), barium (Ba), and radium (Ra). The alkaline earth metal is preferably at least one selected from the group consisting of Mg. Ca, Sr, and Ba, more preferably Mg or Ca, particularly preferably Ca.

Examples of the other metal include at least one selected from the group consisting of aluminum (Al), gallium (Ga), indium (In), thallium (Tl), zinc (Zn), cadmium (Cd), gold (Au), silver (Ag), copper (Cu), and rare earth metals such as scandium (Sc), yttrium (Y), lanthanoid elements, and actinoid elements. The other metal is preferably at least one selected from the group consisting of Al and rare earth metals, and more preferably Al.

Examples of the anion of the metal salt include a halogen ion, a carbonate ion, a sulfate ion, a phosphate ion, a nitrate ion, and a carbonate ion. The anion of the metal salt is preferably a halogen ion. The halogen ion has a wide electrochemical window; allowing the reaction to proceed without bath decomposition.

The halogen may be at least one selected from the group consisting of fluoride (F), chloride (Cl), bromide (Br), iodine (I), and astatine (At). The halogen is preferably at least one selected from the group consisting of F, Cl, Br, and I, more preferably at least one of F or Cl. In one aspect, halogen is Cl. In another aspect, halogen is F.

Specific examples of the raw material of the molten salt include an alkali metal halide such as LiF, NaF, KF, RbF, CsF, LiCl, NaCl, KCl, RbCl, CsCl, LiBr, NaBr, KBr, RbBr, CsBr, LiI, NaI, KI, RbI, and CsI; an alkaline earth metal halide such as MgF₂, CaF₂, SrF₂, BaF₂, MgCl₂, CaCl₂, SrCl₂, BaCl₂, MgBr₂, CaBr₂, SrBr₂, BaBr₂, MgI₂, CaI₂, SrI₂, and BaI₂; an aluminum halide such as AlCl₃; a metal carbonate such as Li₂CO₃, Na₂CO₃, and K₂CO₃; a metal nitrate such as LiNO₃, NaNO₃, and KNO₃; and an oxide of metals such as Li₂O and CaO. The raw material of the molten salt is preferably at least one selected from the group consisting of a lithium salt, a sodium salt, and a potassium salt. The raw material of the molten salt is more preferably a chloride or fluoride, preferably a chloride, of at least one selected from the group consisting of Li, Na, and K.

The metal salt and metal oxide above may be used alone or in combination of two or more. It is preferable to use two or more metal salts and metal oxides in combination from the viewpoint that the melting temperature is easily lowered. For example, a combination of a plurality of chlorides, a combination of a plurality of fluorides, and a combination of one or more chlorides and one or more fluorides may be used. Specific examples of such combinations include combinations of LiCl with KCl, LiCl and KCl with CaCl₂, LiF and NaF with KF, NaF with NaCl, and NaCl and KCl with AlCl₃.

In a preferred aspect, the molten salt is prepared from at least one and preferably two or more metal salts selected from the group consisting of LiF, NaF, KF, RbF, CsF, LiCl, NaCl, and KCl. Such a metal salt may preferably be a combination of LiCl and KCl.

In the combination of a plurality of salts, a compounding ratio thereof is not particularly limited. In the combination of LiCl with KCl, for example, the number of moles of LiCl may be 10 mol % or more, 30 mol % or more, 45 mol % or more, or 50 mol % or more with respect to the total number of moles of LiCl and KCl. The number of moles of LiCl may be 90 mol % or less, 70 mol % or less, or 65 mol % or less with respect to the total number of moles of LiCl and KCl. In one aspect, the number of moles of LiCl may be 10 mol % or more and 90 mol % or less, preferably 45 mol % or more and 70 mol % or less with respect to the total number of moles of LiCl and KCl.

The C source is preferably a metal carbide, more preferably an alkali metal or alkaline earth metal carbide, and even more preferably an alkaline earth metal carbide. Such alkali metals and alkaline earth metals include the same as those described above.

Specific examples of the C source include Li₂C₂, Na₂C₂, K₂C₂, Rb₂C₂, BeC₂, MgC₂, CaC₂, and SrC₂. The C source is preferably Li₂C₂, Na₂C₂, or CaC₂, more preferably CaC₂. The use of Li₂C₂, Na₂C₂, or CaC₂, especially CaC₂, allows the metal carbide to be easily dissolved by the molten salt.

The metal carbide can be used as M¹C₂ or M²₂C₂ (M¹ is an alkaline earth metal and M² is an alkali metal) obtained by reducing CO₂ at the cathode. In other words, CO₂ can also be a C source.

The N source can be preferably a metal nitride or nitrogen gas. The N source is preferably a metal nitride, more preferably an alkali metal or alkaline earth metal nitride, and even more preferably an alkali metal nitride. Such alkali metals and alkaline earth metals include the same as those described above.

Specific examples of the N source include N₂, Li₃N, Na₃N, K₃N, Rb₃N, Be₃N₂, Mg₃N₂, Ca₃N₂, and Sr₃N₂. The N source is preferably Li₃N, Na₃N, Mg₃N₂, and Ca₃N₂, more preferably Li₃N. The use of Li₃N, Na₃N, Mg₃N₂, and Ca₃N₂, especially Li₃N allows the metal nitride to be easily dissolved by the molten salt.

The compounding ratio of the C source to the N source is not particularly limited. The C atoms in the C source can be, for example, 5 mol % or more, preferably 10 mol % or more, more preferably 20 mol % or more, and even more preferably 30 mol % or more, with respect to the total number of moles of C atoms in the C source and N atoms in the N source. The C atoms in the C source can be, for example, 95 mol % or less, preferably 70 mol % or less, more preferably 50 mol % or less, with respect to the total number of moles of C atoms in the C source and N atoms in the N source. In one aspect, the C atoms in the C source can be 5 mol % or more and 95 mol % or less, preferably 20 mol % or more and 70 mol % or less, more preferably 30 mol % or more and 50 mol % or less, with respect to the total number of moles of C atoms in the C source and N atoms in the N source.

The concentrations of the carbon anion (e.g., C₂²⁻) and nitrogen anion (e.g., N³⁻) in the molten salt are not particularly limited as long as they are contained in amounts at which the electrolysis reaction occurs. The concentration of the carbon anion in the molten salt can be preferably 0.1 mol % or more, more preferably 0.3 mol % or more, and even more preferably 0.5 mol % or more, for example 1.0 mol % or more. The upper limit of the concentration of the carbon anion in the above molten salt may be, but is not particularly limited to, 20 mol % or less, 10 mol % or less, 5.0 mol % or less, or 2.0 mol % or less, for example. The concentration of the carbon anion in the molten salt can be preferably 0.1 to 10.0 mol %, more preferably 0.2 to 5.0 mol %, and even more preferably 0.3 to 2.0 mol %. The concentration of the nitrogen anion can be preferably 0.1 mol % or more, more preferably 0.5 mol % or more, and even more preferably 0.8 mol % or more, for example 1.0 mol % or more. The upper limit of the concentration of the nitrogen anion in the above molten salt may be, but is not particularly limited to, 20 mol % or less, 10 mol % or less, 8.0 mol % or less, or 3.0 mol % or less, for example. The concentration of the nitrogen anion can be preferably 0.1 to 10.0 mol %, more preferably 0.5 to 8.0 mol %, and even more preferably 0.8 to 3.0 mol %. Higher concentrations of carbon and nitrogen anions result in more efficient formation of C₃N₄.

### (2) Pulse Electrolysis

The molten salt containing the carbon and nitrogen anions is then subjected to pulse electrolysis. In the method of the present disclosure, a high current density is applied only for a short time by subjecting the molten salt containing carbon and nitrogen anions to pulse electrolysis, and a nonequilibrium field is induced to produce C₃N₄, which is a nonequilibrium substance. According to the method of the present disclosure, C₃N₄ can be produced on a base material with an arbitrary shape.

The pulse electrolysis is performed in the electrolyzer of the present disclosure above.

When a pulse potential is applied between the anode and the cathode in the electrolyzer, an oxidation reaction of carbon anions (e.g., C₂²⁻) and nitrogen anions (e.g., N³) occurs at the anode to produce C₃N₄ (reaction formula (1)). On the other hand, at the cathode, for example, a reduction reaction of a metal ion (e.g., Ca²⁺) occurs to produce a metal (e.g., Ca) (reaction formula (2)).

3/2C₂²⁻+4N³⁻→C₃N₄+14e⁻ (1)

Ca²⁺+2e⁻→Ca (2)

The potential-time graph in the pulse electrolysis of the present disclosure shows a rectangle. In other words, from the potential application pausing state, a cycle is repeated in which a predetermined potential is applied, the potential is held for a predetermined time, and then the potential application is paused, resulting in the potential application pausing state. FIG. 2 shows a typical potential-time graph in the pulse electrolysis of the present disclosure.

In the pulse electrolysis of the present disclosure, the potential during potential application (hereinafter also referred to as the pulse potential) may be preferably 0.10 to 5.00 V, more preferably 0.30 to 3.20 V, and even more preferably 1.00 to 3.00 V, for example, 1.80 to 2.60 V or 2.00 to 2.50 V. The pulse potential can be set to such a range, for example, to suppress the formation of by-products derived from the molten salt and to more efficiently produce C₃N₄, where the potential is a potential of the working electrode (i.e., anode) with respect to the Ag⁺/Ag electrode, which is a reference electrode.

In the pulse electrolysis of the present disclosure, the potential application time (Tₒₙ in FIG. 2) may be preferably 5.0 seconds or less, more preferably 3.0 seconds or less, even more preferably 2.0 seconds or less, still more preferably 1.5 seconds or less, particularly preferably 1.0 seconds or less, and most preferably 0.5 seconds or less. A shorter potential application time promotes the induction of a nonequilibrium field to more efficiently produce C₃N₄. The potential application time may be preferably 0.01 seconds or more, more preferably 0.05 seconds or more, for example, 0.1 seconds or more. In one aspect, the potential application time may be 0.01 to 5.0 seconds, preferably 0.01 to 2.0 seconds, more preferably 0.01 to 1.0 seconds, for example, 0.1 to 0.5 seconds.

In the pulse electrolysis of the present disclosure, the potential during the pause of potential application is an open circuit potential, where the potential in a circuit is a potential of the working electrode (i.e., anode) with respect to the Ag⁺/Ag electrode, which is a reference electrode, in the non-energized state.

In the pulse electrolysis of the present disclosure, the pause time of the potential application (T_{off} in FIG. 2) may be preferably 1.0 seconds or more, more preferably 3.0 seconds or more, even more preferably 5.0 seconds or more, and still more preferably 8.0 seconds or more. By increasing the potential application pausing time, carbon and nitrogen anions in the molten salt sufficiently diffuse, and the lowered carbon and nitrogen anions concentrations in the molten salt near the working electrode are sufficiently recovered. The pause time of the potential application may be preferably 60 seconds or less, more preferably 30 seconds or less, and even more preferably 15 seconds or less, for example, 10 seconds or less. A shorter potential application pausing time enables a shorter pulse cycle period, thereby enhancing reaction efficiency. In one aspect, the pause time of the potential application may be 1.0 to 60 seconds, more preferably 5.0 to 30 seconds, for example, 8.0 to 15 seconds.

The duty cycle (Tₒₙ/(Tₒₙ+T_{off})) in the pulse electrolysis of the present disclosure may be preferably 0.001 to 0.5, more preferably 0.01 to 0.1. By setting the duty ratio to such a range, C₃N₄ is produced more efficiently.

The number of pulse cycles in the pulse electrolysis of the present disclosure is not particularly limited. The number of pulse cycles may be, for example, 1 cycle or more, preferably 10 cycles or more, more preferably 20 cycles or more. An increase in the number of cycles can increase the yield (weight and number) of C₃N₄, resulting in formation of larger C₃N₄ crystals. The number of pulse cycles may be, for example, 1000 cycles or less, preferably 500 cycles or less, more preferably 100 cycles or less, for example, 50 cycles or less. A reduced number of cycles can suppress a decrease in the reaction rate.

The temperature of the molten salt in the pulse electrolysis of the present disclosure is not particularly limited but may be, for example, 200 to 1000° C., more preferably 300 to 800° C., and even more preferably 400 to 600° C. The pulse electrolysis of the present disclosure has high energy efficiency because the reaction proceeds at a relatively low temperature.

The pulse electrolysis of the present disclosure is preferably performed under a nitrogen or rare gas atmosphere, preferably under a rare gas atmosphere. When the pulse electrolysis is performed under a nitrogen or rare gas atmosphere, side reactions can be suppressed, thereby forming C₃N₄ with higher purity.

Examples of the rare gas include helium, neon, and argon, and argon is preferable.

In one aspect, the pulse electrolysis of the present disclosure is performed under an argon atmosphere.

In one aspect, the pulse electrolysis of the present disclosure is performed under a nitrogen atmosphere.

The nitrogen and rare gas are preferably continuously injected into the system during the pulse electrolysis. In other words, it is preferable to keep purging the system with these gases. Side reactions can be further suppressed by continuous injection of nitrogen gas and rare gas into the system.

The nitrogen and rare gases may be directly injected into the molten salt or may be injected into a space above the molten salt inside the electrolytic cell. In a preferred aspect, the nitrogen and rare gases are injected directly into the molten salt. The nitrogen gas or rare gas can be directly injected into the molten salt to efficiently remove gas contained as an impurity in the molten salt, thereby further suppressing the side reactions.

When nitrogen is used, such nitrogen is ionized in the molten salt to N³⁻, which can serve as an N source.

A nitrogen atmosphere may be generated by using a nitrogen electrode as a cathode. In this case, since nitrogen is supplied from the nitrogen electrode, the gas injection member need not be installed.

Thus, the carbon nitride and the method for producing carbon nitride according to the present disclosure have been described in detail. Note that the applications of the carbon nitride of the present disclosure are not limited to those exemplified above.

### EXAMPLES

Hereinafter, the present disclosure is described in Examples, but the present disclosure is not limited to the following Examples.

### Experimental Example 1

LiCl and KCl were mixed to make LiCl/KCl=59.0 mol %/41.0 mol %, and the mixture was vacuum dried at 200° C. and 100 Pa or less for 24 hours or more to form a mixed salt of LiCl and KCl. 0.5 mol % of CaC₂ and 1.8 mol % of Li₃N, with respect to the total number of moles of LiCl and KCl, were added to the resulting mixed salt to obtain a raw material mixture of molten salts. The raw material mixture was added to an electrolytic cell in a Pyrex holder (corresponding to the lower closed container in FIG. 1), heated to 450° C., and melted. Thus, a molten salt of LiCl—KCl—CaC₂—Li₃N was formed.

The Pyrex holder was then sealed with a lid (corresponding to the upper sealed container in FIG. 1) fitted with a working electrode (5 mm Pt wire), a counter electrode (glassy carbon), a reference electrode (Ag⁺/Ag), a gas injection pipe, and a gas exhaust pipe. At this time, the working electrode, counter electrode, reference electrode, and gas injection pipe were immersed in the molten salt in the electrolytic cell. Argon gas was continuously flowed from the gas injection pipe and discharged from the gas exhaust pipe.

Then, the oxidation behavior of the molten salt was observed by measuring the current density through application of a potential between the working electrode and the counter electrode at a scanning speed of 100 mV/s by cyclic voltammetry.

### Comparative Example 1

The oxidation behavior of the molten salt was observed in the same manner as in Example 1 except that no Li₃N was added to the molten salt.

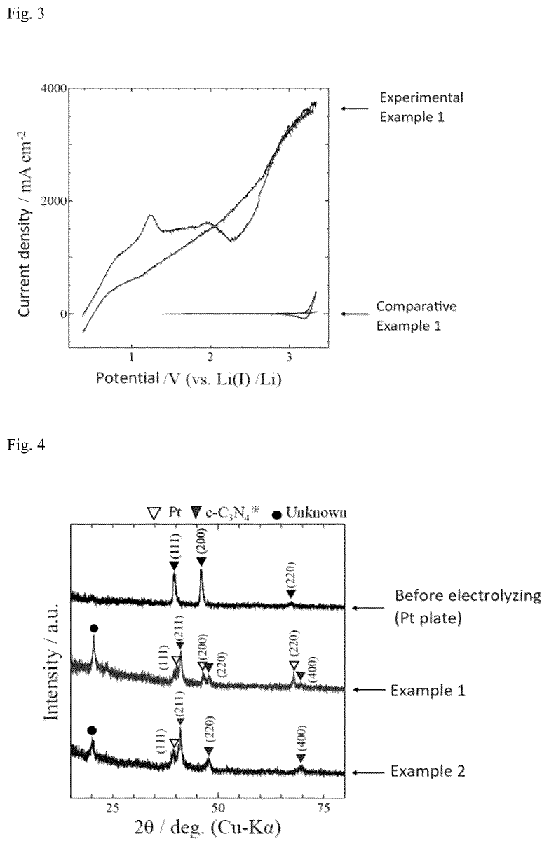

FIG. 3 shows results of Example 1 and Comparative Example 1. The results in FIG. 3 confirmed the oxidation current in the range of 0.3 to 3.2 V in Experimental Example 1.

### Example 1

A molten salt of LiCl—KCl—CaC₂—Li₃N was obtained in the same manner as in Experimental Example 1. The Pyrex holder was then sealed with a lid (corresponding to the upper sealed container in FIG. 1) fitted with a working electrode (1 cm×1.5 cm Pt plate), a counter electrode (glassy carbon), a reference electrode (Ag⁺/Ag), a gas injection pipe, and a gas exhaust pipe. At this time, the working electrode, counter electrode, reference electrode, and gas injection pipe were immersed in the molten salt in the electrolytic cell. Argon gas was continuously flowed from the gas injection pipe and discharged from the gas exhaust pipe.

Then, a pulse potential with a potential application time (Tₒₙ) of 0.5 seconds and a pause time (T_{off}) of 10 seconds was applied for 10 cycles using a potentiostat/galvanostat with the potential of the working electrode with respect to the reference electrode during potential application being set at 2.00 V.

After the pulse potential was applied, electrodeposits were observed on the surface of the working electrode.

### Example 2

Pulse electrolysis was performed in the same manner as in Example 1 except that the potential of the working electrode with respect to the reference electrode during potential application was set to 2.28 V.

After the pulse potential was applied, electrodeposits were observed on the surface of the working electrode.

### Example 3

Pulse electrolysis was performed in the same manner as in Example 1 except that the potential of the working electrode with respect to the reference electrode during potential application was set to 2.50 V.

After the pulse potential was applied, electrodeposits were observed on the surface of the working electrode.

### Example 4

Pulse electrolysis was performed in the same manner as in Example 3 except that the number of cycles was changed to 20.

After the pulse potential was applied, electrodeposits were observed on the surface of the working electrode.

### Example 5

Pulse electrolysis was performed in the same manner as in Example 1 except that the potential of the working electrode with respect to the reference electrode during potential application was set to 1.70 V.

### <Evaluation>

### (X-Ray Diffraction Analysis)

The electrodeposits obtained in Example 1 to 5 were subjected to XRD analysis using MultiFlex (manufactured by Rigaku Corporation) under the following measurement conditions. FIGS. 4, 5, and 6 shows results of Examples 1 and 2, results of Examples 34 and 4, and results of Example 5, respectively.

### Measurement Conditions

Radiation source: Cu—Kα radiation
Scan range (2θ): 15 to 80°
Step size (2θ): 0.02°
Scanning speed: 0.5°/min
Voltage: 40 kV
Current: 20 mA

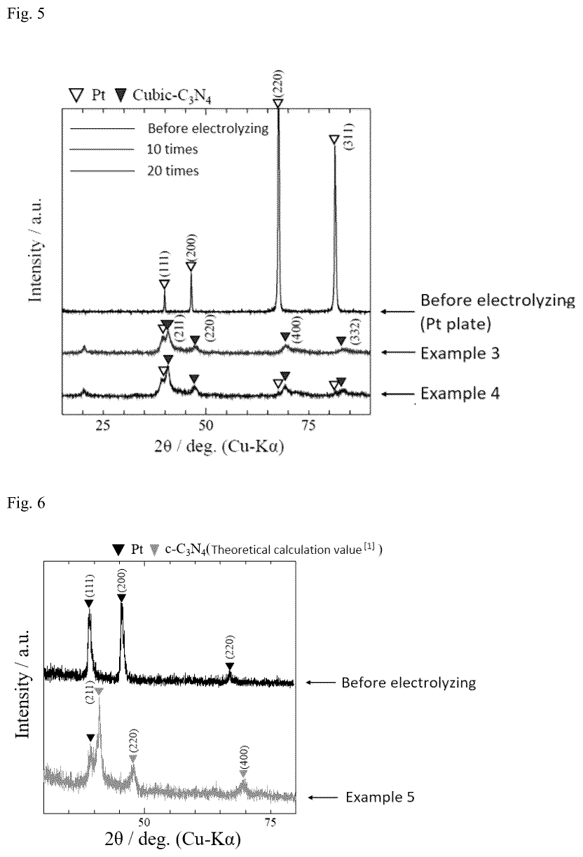

The results of FIGS. 4 and 6 confirmed that the electrodeposits obtained in Examples 1, 2, and 5 had peaks at 41.0°, 47.7°, and 69.3° (2θ). By comparison with the theoretical values, it was confirmed that the peaks of 41.0°, 47.7°, and 69.3° are peaks of the (211), (220), and (400) planes of the cubic C₃N₄ crystal, respectively. The result of FIG. 5 confirmed that the electrodeposit also had a peak of 83.8°, where the peak was a peak of the (332) plane of the cubic C₃N₄ crystal.

### (Scanning Electron Microscope)

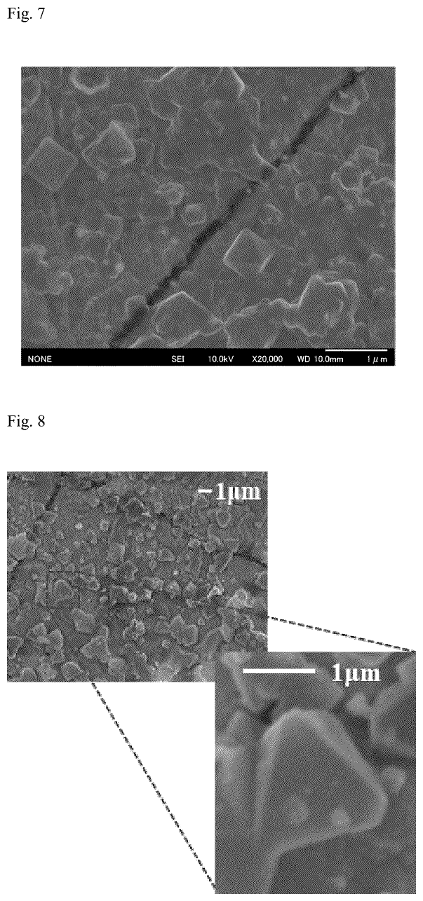

The electrodeposits obtained in Examples 2 and 5 were observed using JSM-7001 FD (manufactured by JEOL Ltd.) under the following measurement conditions. FIGS. 7 and 8 each shows the obtained image.

### Measurement Conditions

Observation magnification: 20,000×
Acceleration voltage: 10.0 kV

The image of FIG. 7 confirmed the formation of the crystal with a regular octahedral structure in the cubic crystal by the method of the present disclosure.

### (Nanoindentation)

Nanoindentation hardness was measured on the electrodeposit obtained in Example 5. As a result, the c-C₃N₄ hardness was 240 GPa.

### INDUSTRIAL APPLICABILITY

The carbon nitride of the present disclosure can be used in various applications as a next-generation functional material.

### REFERENCE SIGNS LIST

1 Electrolyzer
2 Anode
3 Cathode
4 Electrolytic cell
5 Reference electrode
6 Gas injection member
7 Gas exhaust member
8 Lower sealed container
9 Upper sealed container
10 Heater
11 Conducting wire
12 Molten salt

1.-22. (canceled)

23. A C₃N₄ crystal with a cubic crystal structure, which has an edge length of 2.0 μm or more.

24. The C₃N₄ crystal according to claim 23, which has peaks at 40.9°, 47.6°, and 69.6° (2θ) in an XRD pattern.

25. The C₃N₄ crystal according to claim 23, which has a C₃N₄ concentration of 99.5% by mass or more in the crystal.

26. A method for producing carbon nitride having a regular octahedral structure having an edge length of 2.0 μm or more, comprising subjecting a molten salt containing carbon and nitrogen anions to pulse electrolysis to oxidize the carbon and nitrogen anions, thereby forming carbon nitride represented by C₃N₄ wherein an anode is a Pt electrode.

27. The method for producing carbon nitride according to claim 26, wherein the carbon and nitrogen anions are C₂²⁻ and N³⁻, respectively.

28. The production method according to claim 26, wherein a potential-time graph in the pulse electrolysis shows a rectangle.

29. The production method according to claim 26, wherein a potential during potential application is 0.10 to 5.00 V in the pulse electrolysis.

30. The production method according to claim 26, wherein a potential application time is 0.01 to 5.0 seconds in the pulse electrolysis.

31. The production method according to claim 26, wherein a potential during a pause of potential application in the pulse electrolysis is an open circuit potential.

32. The production method according to claim 26, wherein a pause time of potential application is 1.0 seconds or more in the pulse electrolysis.

33. The production method according to claim 26, wherein the pulse electrolysis is performed under a nitrogen atmosphere or rare gas atmosphere.

34. The production method according to claim 33, wherein the rare gas atmosphere is an argon atmosphere.

35. The production method according to claim 26, wherein a cathode is an electrode of Ag, Cu, Ni, Pb, Hg, Tl, Bi, In, Sn, Cd, Au, Zn, Pd, Ga, Ge, Ni, Fe, Pt, Pd, Ru, Ti, Cr, Mo, W, V, Nb, Ta, Zr, or an alloy thereof, glassy carbon, natural graphite, isotropic graphite, pyrolytic graphite, plastic formed carbon, conductive diamond, or nitrogen.

36. The production method according to claim 26, wherein the cathode is a glassy carbon electrode.

37. The production method according to claim 26, wherein the molten salt is a molten salt of one or more salts selected from alkali metal or alkaline earth metal halides.

38. The production method according to claim 26, wherein a carbon anion source is CaC₂.

39. The production method according to claim 26, wherein a nitrogen anion source is Li₃N.

40. A C₃N₄ crystal with a cubic crystal structure, which has peaks at 40.9°, 47.6°,and 69.6° (2θ) in an XRD pattern.

41. The C₃N₄ crystal according to claim 40, which has a C₃N₄ concentration of 99.5% by mass or more in the crystal.
